(19) United States
(12) Patent Application Publication
(10) Pub. No.: US 2015/0220857 A1
(43) Pub. Date: Aug. 6, 2015

(54) STORE SERVICE WORKBENCH

(71) Applicant: SYNTEL, INC., TROY, MI (US)

(72) Inventor: Ashok Balasubramanian, Irving, TX (US)

(21) Appl. No.: 14/687,251

(22) Filed: Apr. 15, 2015

Related U.S. Application Data
(63) Continuation of application No. 13/648,513, filed on Oct. 10, 2012.
(60) Provisional application No. 61/545,244, filed on Oct. 10, 2011.

(51) Int. Cl. G06Q 10/06; G06Q 10/10; H04W 4/02; G06Q 50/20

(52) U.S. Cl. CPC G06Q 10/063; G06Q 10/06393; G06Q 10/06311; G06Q 10/06395; G06Q 50/2057; G06Q 10/103; G06Q 10/063118; G06Q 10/063114; G06Q 10/0633; H04W 4/021

(57) ABSTRACT

A computerized system for use with business entities having multiple locations. The computer system is programmed with one or more of the following non-exhaustive list of modules: a dashboard module, a task management module, an audit management module, a training module, and a collaboration module. The dashboard module is configured to allow users to view key performance indicators based on the role of the user requesting the report. The task management module allows management of tasks among users and geographic locations. The audit management module is configured to allow users to create a checklist of business activities and a manner by which stores can be scored based on completion of the checklist. The training module provides the ability to train users, such as using web-based content. The collaboration module is configured to allow communication and collaboration among users.

### RELATED APPLICATIONS

This application claims the benefit of U.S. Provisional Application Ser. No. 61/545,244 filed Oct. 10, 2011, for a “Store Service Workbench,” which is hereby incorporated by reference in its entirety.

### TECHNICAL FIELD

The invention relates generally to computerized systems and methods used in conjunction with retail store operations; more particularly, the invention relates to computerized tools for supporting and facilitating various business processes involved in store operations.

### BACKGROUND

Daily retail store operations typically include activities related to processes such as promotions, inventory, workforce, signage and labels and others. To operate these processes uniformly, both stores and corporate office(s) often need to perform the following action points:
Collate and track information about different key performance indicators (“KPI”), including but not limited to sales and inventory.
Assign tasks to store associates, follow-up on task progress, and manage task reviews and approvals.
Track, review, and audit store activities as per quality standards and operational compliance.
Conduct different trainings for store associates like customer service, product demo, merchandise setup and others.
Share information about operations' status in terms of different documents.

To perform the above mentioned tasks and activities, users at corporate office(s) and stores generally have to interact with multiple systems. It becomes a tedious and time consuming task for store users to view KPI details on one system and take actions by assigning tasks another other system. Also, information spread over disparate systems often leads to ambiguity. Moreover, store users need to spend their maximum amount of time on the sales floor so they can serve customers in a better way. In order to reduce the complexity and dependency on multiple systems, there is a need for an integrated platform to cover multiple aspects of store operations.

### SUMMARY

As should be appreciated by one of skill in the art, the present invention may be embodied in many different forms, such as one or more devices, methods, data processing systems, and/or computer program products. Accordingly, embodiments of the invention may take the form of an entirely software embodiment, or an embodiment combining hardware and software aspects. Furthermore, embodiments of the invention may take the form of a computer program product on a non-transitory computer-readable storage medium having computer-readable program code embodied in the storage medium. Any suitable non-transitory storage medium may be utilized including read-only memory (“ROM”), RAM, DRAM, SDRAM, hard disks, CD-ROMs, DVD-ROMs, any optical storage device, and any magnetic storage device.

According to one aspect, the invention provides a computerized system having a software application, which will be referred to as the Store Service Workbench (“SSW”). In some embodiments, the SSW may include one or more of the following non-exhaustive list of modules:

1. Dashboard and Reporting

2. Task Management

3. Store Operations Audit

4. Training

5. Collaboration

In the dashboard and reporting module, a system is provided to view pre-defined KPI reports. These reports pull data from existing data warehouse into data cubes. This type of reporting system makes it convenient for a corporate office to share only useful information with store users without giving access to a complete data warehouse and without putting excess load on the existing reporting system.

In the task management module, a company-wide project tracking system is provided. This module enables corporate office managers to assign store operation related tasks across all the stores. Store managers can also assign store specific tasks to store associates. Store associates can update the status of assigned tasks on the same system and hence tracking of assigned tasks and reporting can all be done on a single system. The system also provides flexibility to define business rules related to task approvals, escalations, and other validations.

In the store operations audit module, a system is provided to audit daily store operations. Store operations may be spread over multiple functions and processes. The corporate office needs to ensure that all the stores are performing and completing store operations as per the organization compliance. This system helps corporate office users in defining day-to-day operations and activities in the form of checklists or questionnaires which are then assigned to store users. Store users typically go through each and every checkpoint of checklists and update the status to ensure that all the activities are completed on time. These checklists are then reviewed or audited by a hierarchy of users to validate the entered results. Records are collected and maintained for all the store operations across all the stores. Reports and graphs are then generated to check operational trends or variance from desired results. Reporting also includes a scoring mechanism for stores to rate and monitor performance of stores.

In the training module, a system is provided to maintain an online library. Corporate office users upload documents in different formats to the online library which is accessible by users across different stores. This eliminates the need for sending out training documents separately to each and every user, such as over email. Moreover, it keeps the training documents in a common location, so store associates can access the files anytime. Additionally, embodiments are contemplated in which the system also provides the function to host videos on a training site which helps in conducting online training for store associates for product demos and other areas where physical training is required.

In the collaboration module, different functions are provided through which users across the stores can create and share information. Different functions available include, but are not limited to, a discussion forum, blogs, and a wiki. The discussions section enables users to start a discussion topic or post their comments to an existing topic. The blogs section provides users with a platform to create a personal blog page which they can use to share their learning and experience with other users. The wiki section provides a function for users to create wikis on important terms and processes and hence in sharing information across the organization.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an example machine that could be used to operate the SSW according to an embodiment of the present invention.

FIG. 2 is a functional overview of SSW explaining different user roles, features of the solution with separate modules, and interaction with other store systems according to one embodiment of the invention.

FIG. 3 is a schematic showing a technical overview of the SSW according to an embodiment of the present invention.

FIG. 4 is an example screen shot of the dashboard module. This screen shows a summary of key KPIs in terms of traffic lights on a single screen.

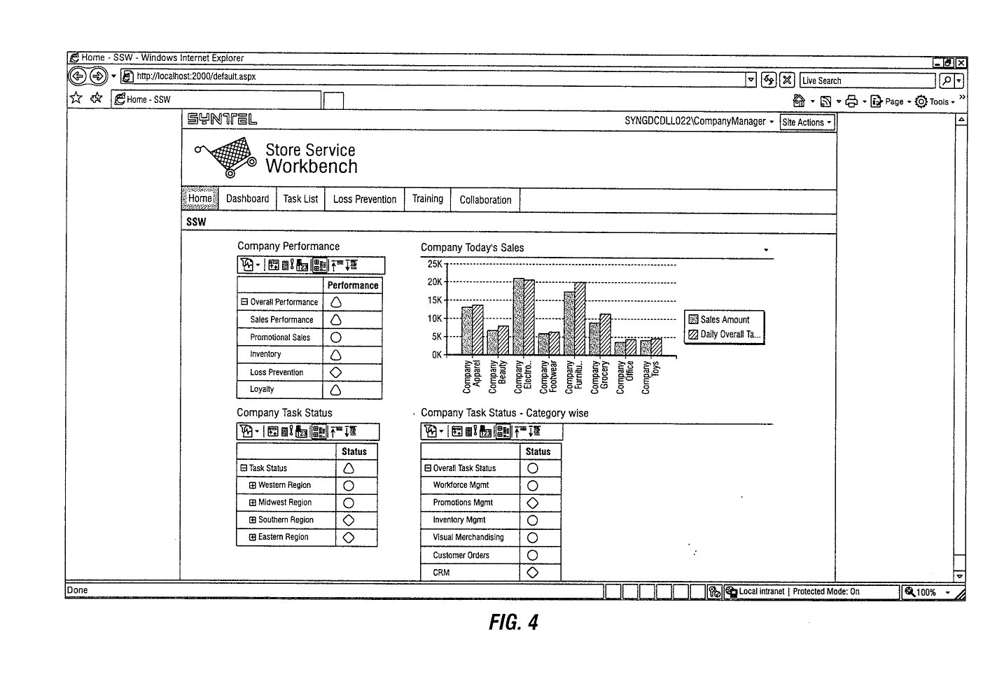

FIG. 5 is an example screen shot of a screen of the dashboard module. This screen shows reports and graphs related to sales performance of regions, stores etc.

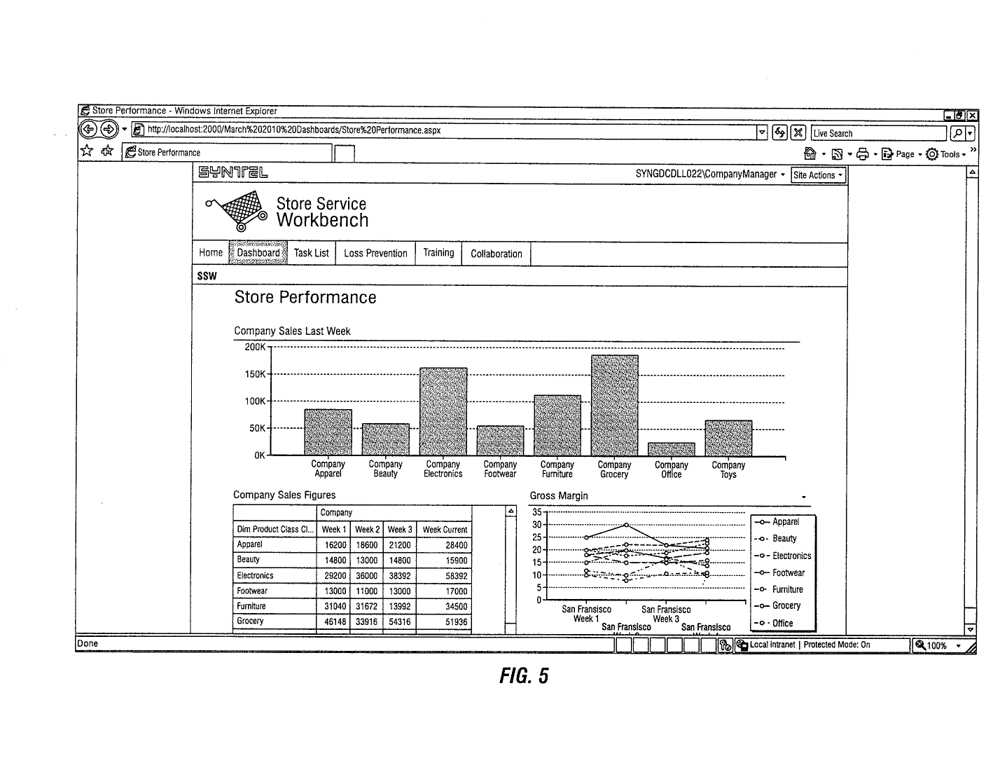

FIG. 6 is an example screen shot showing the “Create Task” feature of the task management module. This screen shows different attributes that can be defined while creating and assigning a task.

FIG. 7 is an example screen shot of “Region Task Details.” This screen shows task attribute details of all the pending tasks grouped by regions.

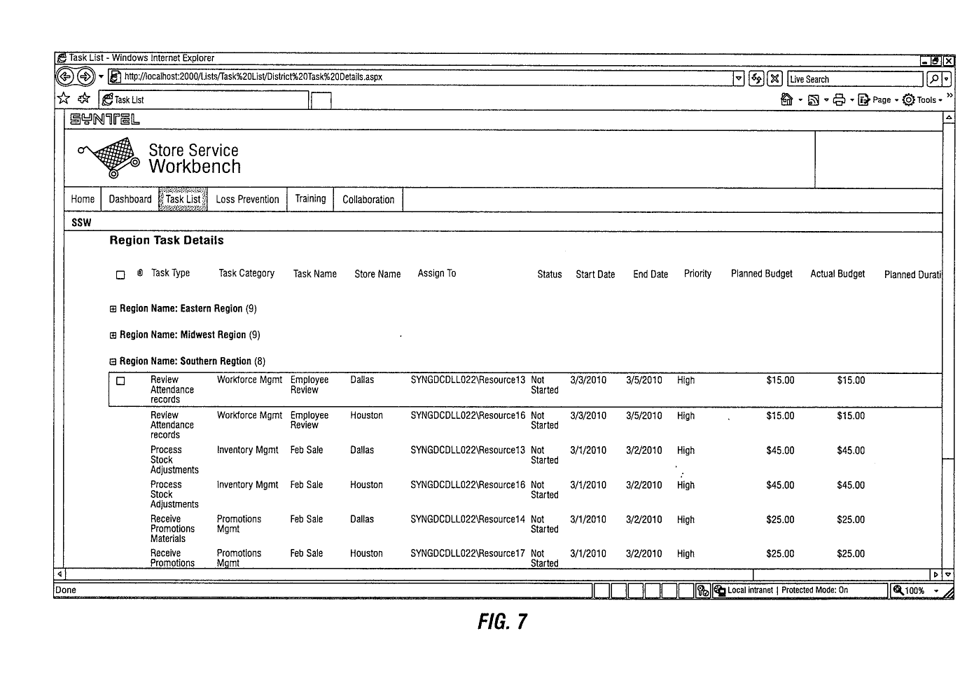

FIG. 8 is an example screen shot showing the “Capacity Matrix” feature of the task management module. This screen shows availability of work hours for each business function across all the stores.

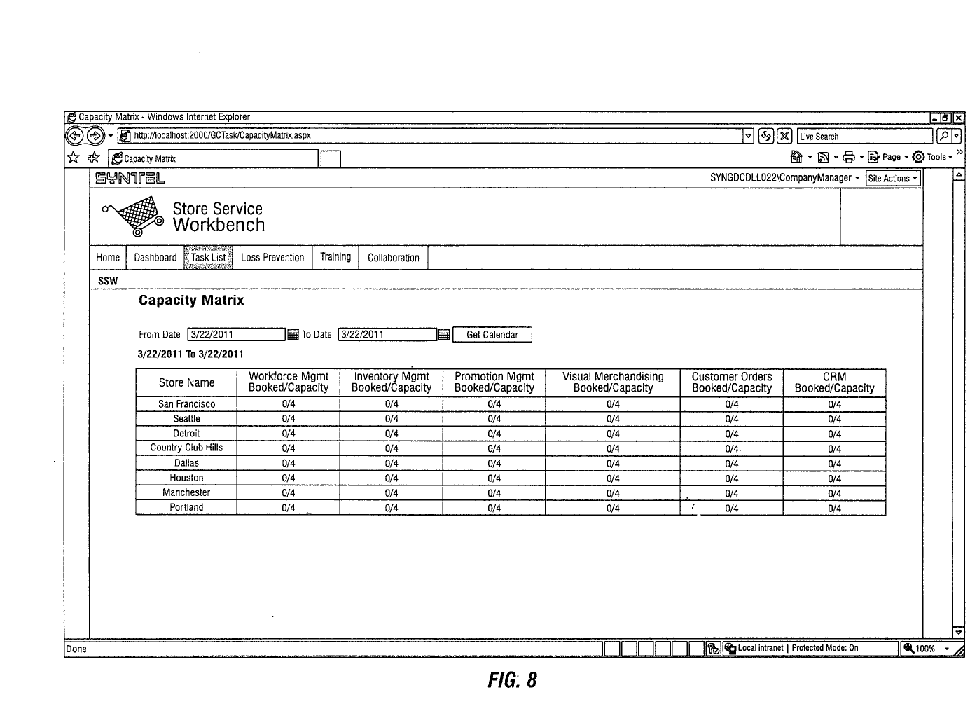

FIG. 9 is an example screen shot of a training module. This screen shows folders of an e-library of the training module.

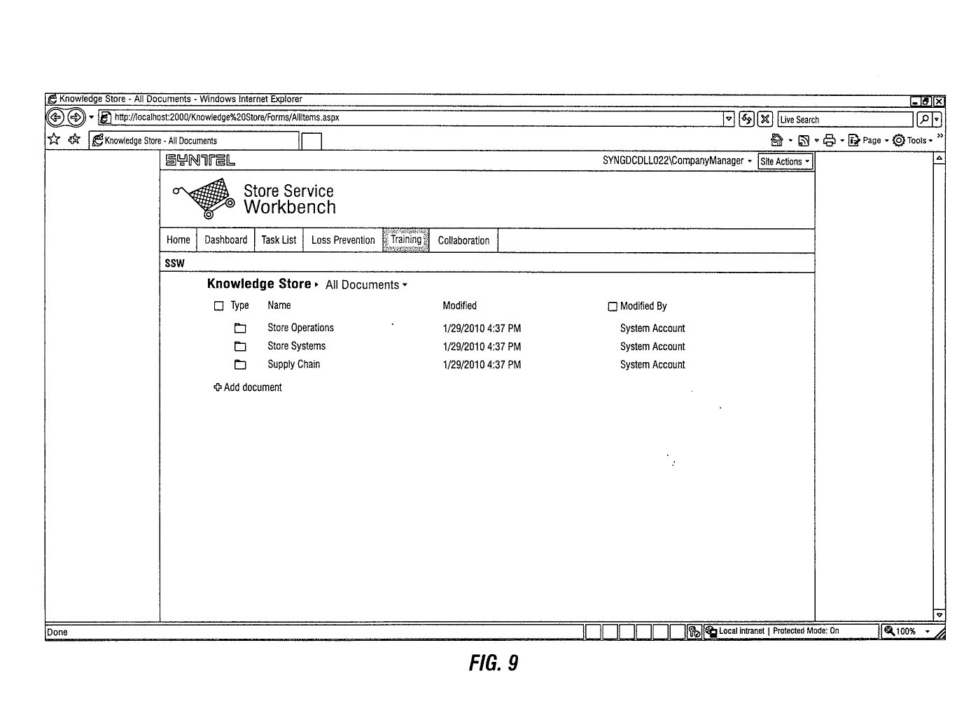

FIG. 10 is a screen shot of the “Videos” feature of the training module. This screen shows embedded training videos on a webpage.

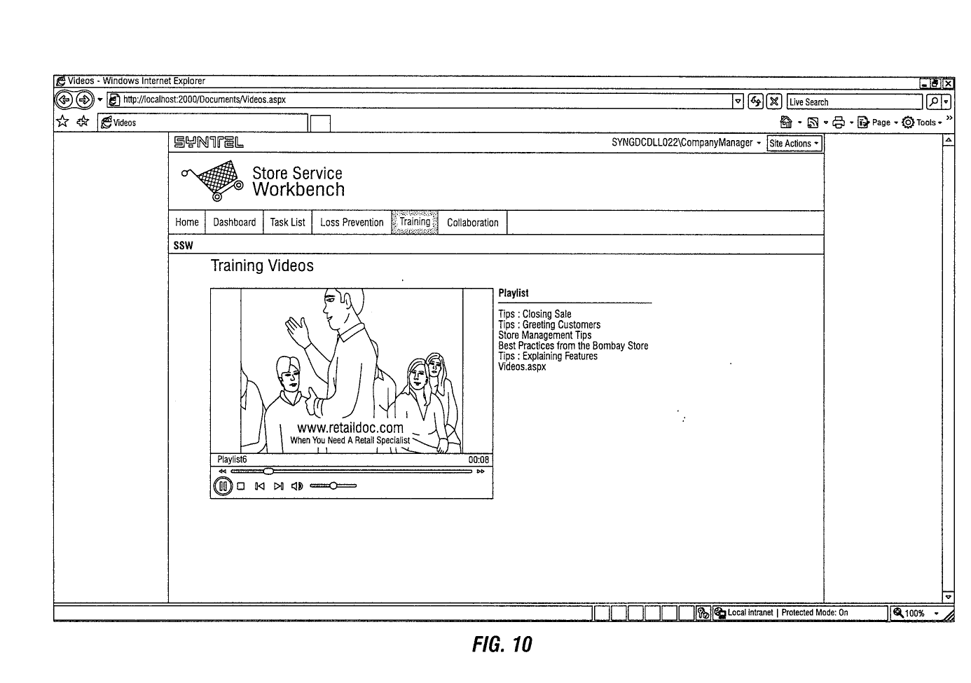

FIG. 11 is a screen shot of the collaboration module. This screen shows posts created by users which are available for discussion under collaboration.

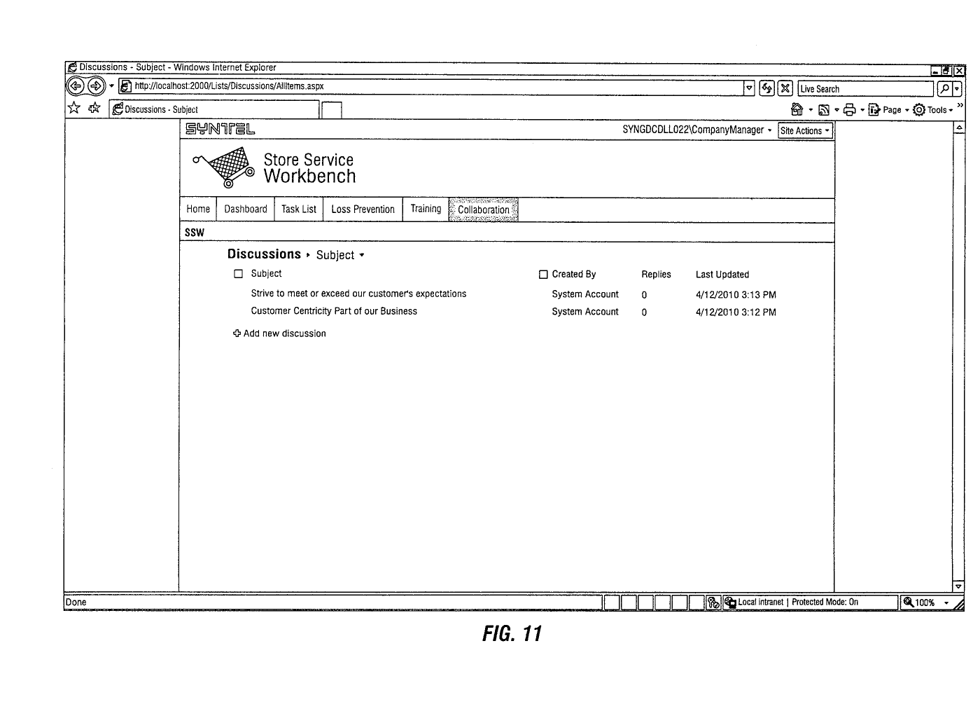

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

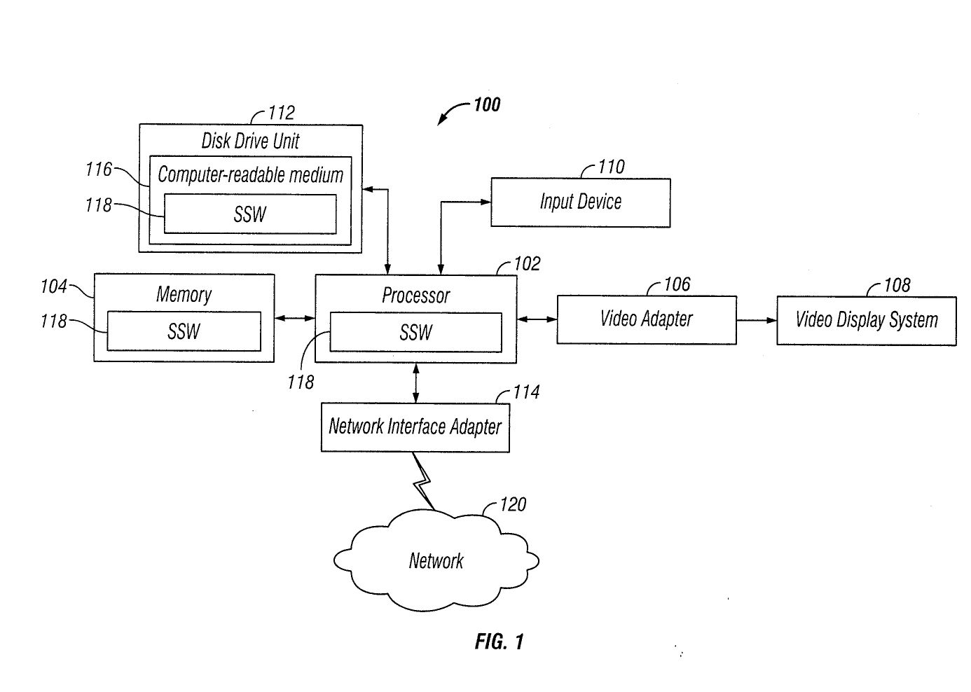

This disclosure relates generally to a computer system and method for supporting and facilitating various business processes involved in store operations. FIG. 1 illustrates a diagrammatic representation of a machine 100 in the example form of a computer system that may be programmed with a set of instructions to perform any one or more of the operations or methods discussed herein. The machine may be a server, a personal computer, a tablet computer, a Personal Digital Assistant (“PDA”), a media player, a cellular telephone, or any machine capable of executing a set of instructions (sequential or otherwise) that specify actions to be taken by that machine. Unless otherwise indicated, use of the term “computer” in this specification is intended to be synonymous with “machine,” as described and defined herein.

The machine 100 may operate as a stand-alone device or may be connected (e.g., networked) to other machines. In embodiments where the machine is a stand-alone device, the set of instructions could be a computer program stored locally on the device that, when executed, causes the device to perform one or more of the methods or operations discussed herein. In embodiments where the computer program is locally stored, data may be retrieved from local storage or from a remote location via a network. In a networked deployment, the machine 100 may operate in the capacity of a server or a client machine in a server-client network environment, or as a peer machine in a peer-to-peer (or distributed) network environment. Although only a single machine may be illustrated in some of the figures, the term “machine” shall also be taken to include any collection of machines that individually or jointly execute a set (or multiple sets) of instructions to perform any one or more of the methods discussed herein.

The example machine 100 illustrated in FIG. 1 includes a processor 102 (e.g., a central processing unit (“CPU”)), a memory 104, a video adapter 106 that drives a video display system 108 (e.g., a liquid crystal display (“LCD”) or a cathode ray tube (“CRT”)), an input device 110 (e.g., a keyboard, mouse, touch screen display, etc.) for the user to interact with the program, a disk drive unit 112, and a network interface adapter 114. Note that various embodiments of the machine 100 will not always include all of these peripheral devices.

The disk drive unit 112 includes a computer-readable medium 116 on which is stored one or more sets of computer instructions and data structures embodying or utilized by a Store Service Workbench (“SSW”) 118 described herein. The computer instructions and data structures may also reside, completely or at least partially, within the memory 104 and/or within the processor 102 during execution thereof by the machine 100; accordingly, the memory 104 and the processor 102 also constitute computer-readable media. Embodiments are contemplated in which the SSW 118 may be transmitted or received over a network 120 via the network interface device 114 utilizing any one of a number of transfer protocols including but not limited to the hypertext transfer protocol (“HTTP”) and file transfer protocol (“FTP”). The network 120 may be any type of communication scheme including but not limited to fiber optic, wired, and/or wireless communication capability in any of a plurality of protocols, such as TCP/IP, Ethernet, WAP, IEEE 802.11, or any other protocol.

While the computer-readable medium 116 is shown in the example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

In the discussion which follows, the term “module” is used in conjunction with the description of the SSW. For the purposes of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices. In some embodiments, the SSW includes 5 modules; however, one skilled in the art should appreciate that more or less modules may be provided depending on the circumstances.

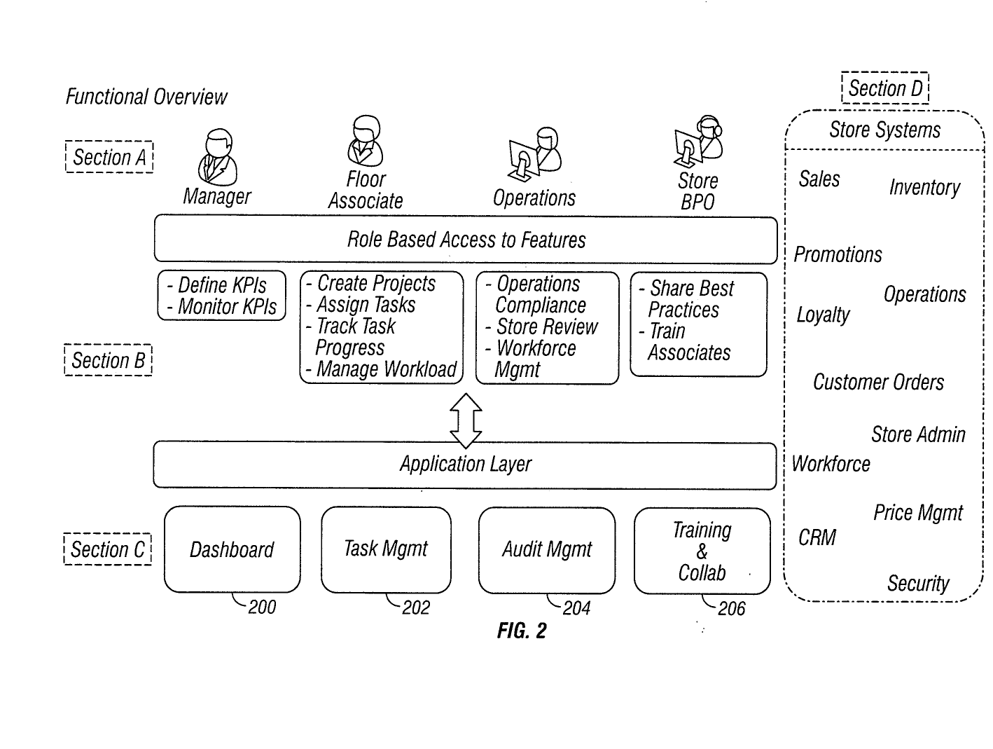

FIG. 2 is a schematic showing a functional overview of the SSW with several modules. In the example shown, the SSW includes a dashboard module 200, a task management module 202, an audit management module 204, a training module 206, and a collaboration module 206.

### Dashboard Module

Traditionally, users at stores do not have easy access to information and reporting systems. Even the information to which they have access lies in different systems. The dashboard module 100 helps users at different levels and locations to view performance of different KPIs on a single system. Data of interest related to some selected KPIs is extracted from an existing data warehouse. The extracted data is processed in the form of dimensions and cubes of data. These dimensions and cubes act as source to generate selected KPI reports. Availability of data in cubes and dimensions reduces dependency on the data warehouse system for lighter reports. Furthermore, it provides an easy to use interface to create reports by selection of required dimensions and fact tables. KPIs of interest and importance from different operation areas can be selected and defined. Reports for these KPIs are then generated using data in the present data warehouse system. Advanced reporting features like drill up and drill down on data elements or multiple views of the same report are available for end user.

### Task Management Module

Store operations span over various business processes such as customer service, inventory management, administration, labels, merchandising, workforce management, etc. To manage and operate these processes, users at corporate office and store managers assign a lot of tasks or activities to store associates. Since these assignments are ad-hoc and offline, it becomes difficult for managers to keep track of status and exceptions related to these activities. SSW provides an organized system to overcome this problem. The task management module 202 enables managers to define tasks, assign to users, track task progress through different reports, and approve or reject tasks. The following are example processes and functions of the task management module:

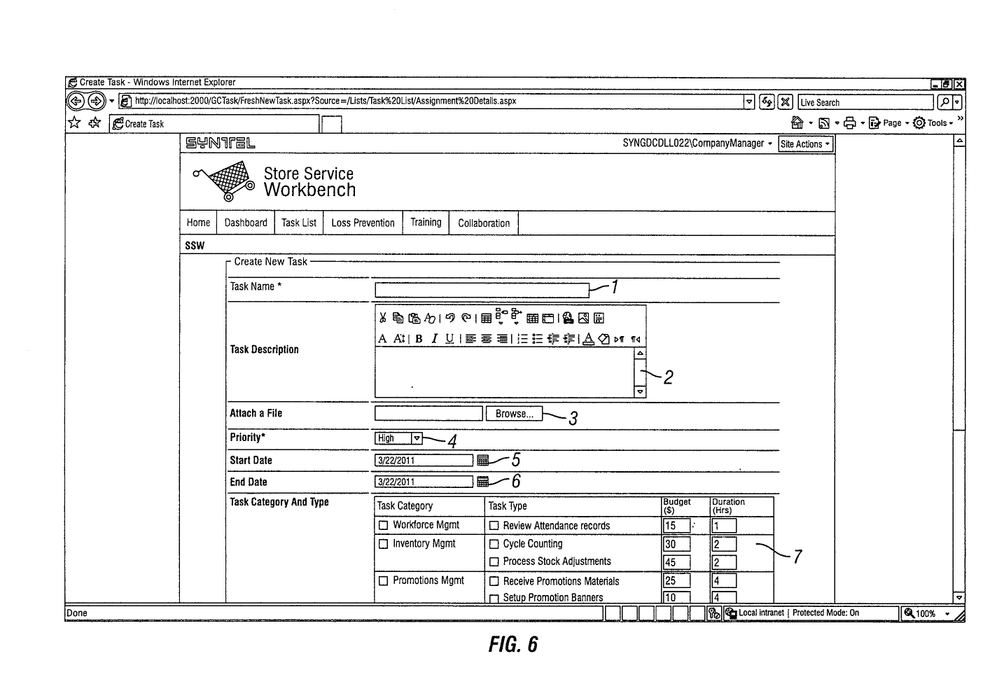

Task Creation—Users at a corporate office or store managers or other users with valid access rights can create and assign the tasks. While creating a task, the user can define various attributes related to task. FIG. 6 shows an example screen shot for a task creation page. As shown, section [1] is provided to define task name. A user can enter a task description in section [2]. Section [3] is for attaching a file to the task like a planogram image or instruction manual. Section [4] is to set the priority of the task. Section [5] and [6] are used to define the duration for the task. One task can have multiple operations tagged to it. From section [7], the user selects all relevant task categories which automatically selects relevant task types. The user also updates budget and duration if required. The user can then select the geography to which he wants to assign the task. He can select one store, group of stores across regions, one or more regions, or the whole company. The user then checks resources which are assigned by the system for the type of task category selected. The user can then assign the task by clicking on “Create Task.”

Task Assignment—A task created by a senior user gets assigned to associates at the store. When they login to the system, these tasks come up on the pending task list. The task can be opened up from this list for editing. Store associates can update the task status as “Not Started,” “In Progress,” or “Completed,” and enter comments in the “Task Feedback” section and then click “Submit” to submit the task.

Task Approval—Tasks submitted by store associates get reassigned to task creators for the review and approval of the task. The task creator reviews the status of the task, task feedback and other details. Based on details, he can then accept or reject the task.

Task Workflows—Task creation and assignments support operations and involve approvals, escalations, and other business rules. To implement this efficiently, task workflows are provided. Some of the workflows which could be pre-built in the system are as follows:

Gatekeeper workflow—At times, task creators are managers at the corporate office and have no clear visibility of resources availability or workload at the store. To avoid discrepancy and lags in such cases, a sub-step of gatekeeper is created. The gatekeeper is a person who receives all the created tasks and has visibility of workload at stores. Based on availability of resources he approves or rejects, the assignment is stored. This helps in aligning the task assignment as per workload and hence improves the efficiency of overall system.

Approval Workflow—Task management acts as a communication medium between hierarchies of users. To make this work effectively, a flexible approval process is provided. When the task status is updated and submitted by a task executor in the system, that task gets assigned to a task creator for his review. The task creator then reviews the task details and can approve or reject the task. If the task is approved, it gets closed; whereas if it gets rejected, then it gets reassigned to the task executor or the alternate person chosen by the task creator.

Capacity Matrix—Tasks are created for multiple stores across different task types. To view the current workload for a business process, a workload analyzer is provided which is known as “capacity matrix.” This function is provided to the gatekeeper. The gatekeeper can enter the dates for which he wants to view the workload of different business processes. The system then shows a summary of booked and assigned hours for all business processes across different stores.

Task Reporting—Senior managers need to keep track of operations. The reporting section enables managers to track and monitor the status of tasks. Reports are available on different attributes. Reports are available to users based on their defined roles and access. The following are example types of task progress reports that could be available for each type of role in system:

Pending Tasks

Tasks assigned by Region, Stores

Overdue Tasks

Completed Tasks

### Audit Management Module

Referring again to FIG. 2, the system includes an audit management module 204 that enables corporate office users to audit daily store operations at stores. The system provides the audit module to create a checklist or questionnaire of different activities related to store operations. The audit module also creates groups for different business processes which enable managers to assign checklists to groups and not individual users. A manager while defining a checklist can assign it to multiple groups to enable review of filled checklists. A user from an assigned group logs into the system to view assigned checklists. He fills up the checklist along with comments for each question or for overall checklist. The user can also save the checklist as draft for later action; otherwise, he can submit it in the system for the next level review. When the next level of user logs into the system, he can view the checklists waiting for his approval. He can edit previous level records and can enter his own set of remarks. Records entered by senior-most level of auditors are considered as final and are used for reporting. The following are examples of reports available in the store audit:

Scoresheet—this report tracks checklists for each business operation and calculates scores based on completion status. The user selects duration and stores to generate a scoresheet. Based on the selection, the scoresheet calculates percent scores for each process per day and overall score for duration.

Scorecard—this report helps in viewing all stores' performance in a single view. This report shows the compliance level of store operations in terms of traffic lights. The user can drill down from region to stores, stores to processes, and from processes to checklists.

### Training and Collaboration Modules

In some embodiments, the system may include a training and collaboration module 206. The system is provided with the training module to maintain an online library. Corporate office users upload documents in different formats on an online library, which is accessible by users across different stores. This eliminates the need for sending out training docs separately to each and every user over email. Moreover, it keeps the training documents in a common location so store associates can access the files anytime. The system also provides function to host videos on training site which helps in conducting online training for store associates for product demos and other areas where physical training is required.

The collaboration module provides different functions for users across multiple stores to create and share information. Different functions available may include, but are not limited to, a discussion forum, blogs, and wiki. The discussions section enables users to start a discussion topic or post their comments to an existing topic. All the posts are reviewed and monitored by a moderator. The blogs section provides the user a platform to create a personal blog page which they can use to share their knowledge and experience with other users. The wikis section provides a function to users to create wikis on important terms and processes and hence in sharing information across the organization.

FIG. 2 provides a functional overview of the system according to an embodiment. Section [A] shows examples of the different types of users present in the system. Each user will get access to functions and modules of the system depending on their roles. Section [B] shows the list of features provided by the SSW for different roles. Section [C] represents different modules of the system that are presented to users at an application layer. Section [D] shows different existing store systems. The SSW interacts with these systems to surface information for various modules. Functionally, the SSW does not need a separate set of applications to support operations and can utilize existing store systems.

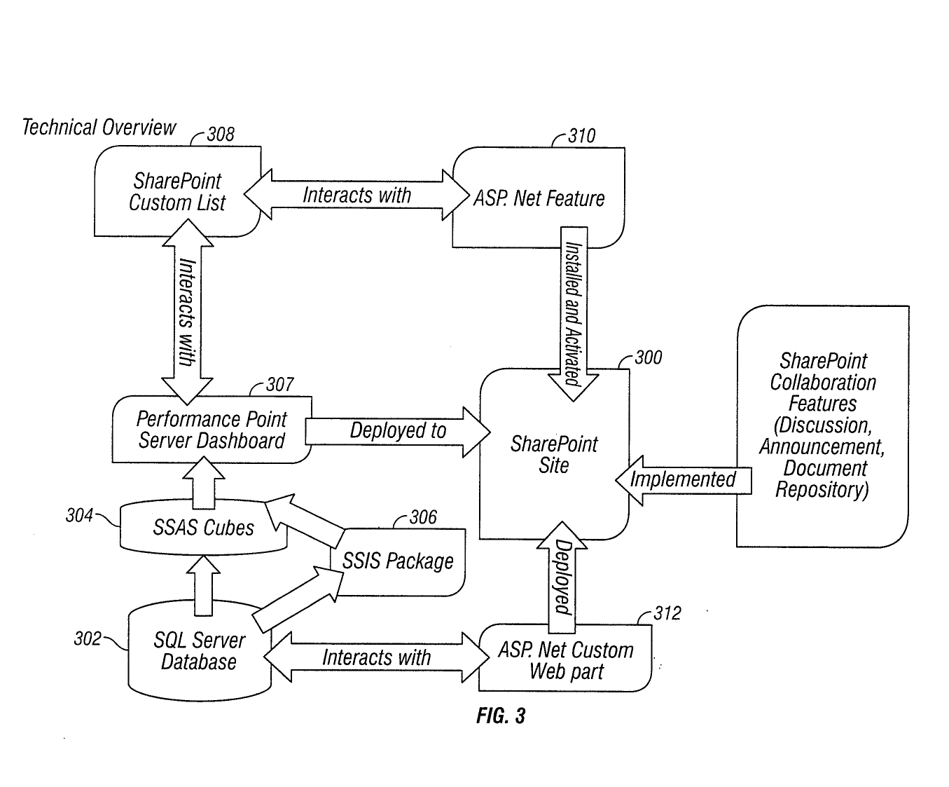

FIG. 3 provides a technical architecture for the system for purposes of example. In the example architecture shown, the SSW is built on a SharePoint platform 300 and utilizes SQL and SharePoint list for a database. Below are the details of each block in this example technical architecture:

SQL Server Database 302: The SQL Server database contains the database for the dashboard module 200 and audit module 204.

SSAS Cube 304: SQL Server Analysis Server cube is formed from the SQL Server database 302 for the dashboard module. PPS scorecards or reports cannot directly communicate with the SQL Server database

SSIS Package 306: SQL Server Integration Service Package maintains the connectivity between SSAS and the SQL server database. Whenever the SQL Server database is modified (a value in the database is modified or inserted or deleted), the SSIS package re-processes the SSAS cube to reflect the change.

PPS Dashboards 307 and dashboard elements are created from SSAS cube. SSAS cube has dimensions and measures which are used to build the reports and KPIs. PPS Dashboards are then deployed to the SharePoint Site.

SharePoint custom lists 308 are used to maintain the task list and the groups and members that are involved in that task management.

Custom Feature 310, designed using C#.net, handles the custom list modification, such as adding elements to the list or modifying the items in the list. This custom feature is then installed and then activated for that particular SharePoint site which we created for SSW.

PPS scorecards can be made from the SharePoint custom list and hence PPS Dashboard designer interacts with the SharePoint custom list to create Task Management related scorecards.

ASP.Net web parts 312 are designed and developed using visual studio. In this example, there are web parts for:

Fetching data from the SQL Server database

Receiving user inputs for store audit

Storing user input into the database

Showing reports for store audit

Different out of box SharePoint features are used for collaboration, such as:

Document repository

Discussion

Announcement

For purposes of example, the following is an example step-by-step deployment for a complete deployment cycle according to one embodiment:
Step 1: Hardware & Software requirements
   Hardware:—SharePoint Server 2010 will be 64 bit only.
   Software: Front End and other SharePoint App Servers
   The Operating system will be required to be Windows Server 2008 64 bit.
   SQL Server back end: The SQL Server environment will require SQL 2005 or SQL 2008 in 64 bit.
   Visual Studio 2010
Step 2: Installation and configuration
   Installation order:
      a. Windows 2008
      b. SQL Server
      c. Visual Studio
      d. SharePoint 2010

Configure SharePoint Server and then configure Performance Point Server.
Step 3: Creating SharePoint Site.
Step 4: Creating database in SQL server for Dashboard.
Step 5: Building SQL Server Analysis Service (SSAS) cubes for dash boarding.
Step 6: Building KPIs, scorecards, analytic reports and dashboard using PPS dashboard designer.
Step 7: Adding dashboard elements into the SharePoint site.
Step 8: Building custom lists in the SharePoint site for task management, resources, stores, and resource calendar.
Step 9: Building ASP.Net features for creating a task (inserting item into SharePoint list), creating holidays (inserting item into SharePoint list to block the resource calendar), and viewing capacity matrix.
Step 10: Install and activate the features in the SharePoint site.
Step 11: Creating SharePoint groups for different hierarchies of task management and adding users into those groups.
Step 12: Building KPIs, Scorecards from the SharePoint custom list for task management reporting purpose.
Step 13: Creating different views of the SharePoint custom list (Task List) for reporting purpose.
Step 14: Developing workflows for managing task management like approving tasks, completing tasks, budget calculation etc.
Step 15: Creating database for Store Audit in SQL Server.
Step 16: Developing visual web parts for creating checklists, filling audit forms, viewing reports.
Step 17: Deploying and adding the web parts into the SharePoint site.
Step 18: Creating SharePoint custom list for Loss Prevention.
Step 19: Developing Dashboard for loss prevention.
Step 20: Adding document repository.
Step 21: Implementing discussion forum.
Step 22: Implementing Announcements
Step 23: Deploying video web parts for Training

Solution Flexibility—In this example, SSW is built on the Microsoft SharePoint platform which offers a lot of customization of features both functionally and technically. This support for customization makes SSW a very flexible solution. Below are examples to help understand the scope of flexibility of SSW by each module.

Dashboard—this module provides performance of different KPIs. All the KPIs are defined by administration and can be edited, added or modified anytime. At present there are around 15 reports present in the system to demo the dashboarding capabilities, but this count is not limited and can be increased based on requirements. Creation of KPIs is simple and completely dependent on the existing database at backend. The system also provides flexibility to create lighter reports by doing selective picking of data elements which reduces burden on bandwidth requirements.

Task Management—this module enables users to easily add or modify task types based on changing requirements. Moreover for some retailers where task types are not properly defined, ad-hoc task creation can also be enabled. Task creation and assignment attributes can be modified based on client requirements. Task workflow, which is one of the most important parts of task management, can be easily modified. New task workflows can be added to accommodate new business rules or validations. The system at present provides reports to track all the operations. However, the system still provides the function to define a new report or to customize existing report type.

Store Operations Audit—based on client requirements, creation and assignment of checklist logic can be easily modified. Addition of workflows to accommodate different business scenarios is possible. More types of reports to track compliance at stores can be added.

Users/Stakeholders—SSW is a system that enables users across hierarchies to communicate effectively. Moreover it helps users at stores to access information related to their stores. The following are example types of roles for users of SSW based on implementation:

Company Managers/Senior Managers/Heads

Region Managers/Field Managers

Operation Managers

Business Managers

Store Managers

Store Administration Managers

Store Associates

Benefits/Advantages—SSW evolves as a single platform to support all communication and resources for store operations. It benefits users on multiple facets, such as:

Metrics Dash-boarding

Flexible Reporting

Streamlined Operations through Task Management

Effective Store Process Compliance with Audit Management

Knowledge Management and Collaboration

Rule Based Alerts

Seamless Convergence across Devices (WIP)

NRF Arts data model based for easy adoption

Reuses MS Office applications

No changes to existing store systems investments

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A computerized system for supporting various business processes of a business entity having a plurality of locations including a first location and a second location, the system comprising:
a dashboard module on a computer configured to provide access to key performance indicators (“KPIs”) of operations of the business entity at least at the first location and the second location;
a task management module on a computer configured to manage tasks by one or more of the following: defining tasks for assignment to one or more users, assigning one or more tasks to users, tracking progress of one or more assigned tasks, and approving or rejecting one or more tasks;
an audit management module on a computer configured to periodically audit business operations at the first location and the second location;
a training module on a computer configured to provide access to training materials over a network; and
a collaboration module on a computer configured to allow communication between users over a network.

2. The system of claim 1, wherein the dashboard module includes one or more predefined KPI reports.

3. The system of claim 2, wherein the dashboard module is configured to populate the KPI reports with data extracted as cubes from a data warehouse.

4. The system of claim 2, wherein the dashboard module is configured to retrieve one or more KPI reports based on identification of a user role requesting the KPI reports.

5. The system of claim 1, wherein the task management module is configured to define tasks for assignment to one or more users by associating a task name, a task description and one or more of a duration of the task, priority of the task, task category, and task budget.

6. The system of claim 5, wherein the task management module is configured to assign one or more tasks by selecting a geographical region of users to whom the task is assigned.

7. The system of claim 6, wherein the task management module is configured to assign one or more tasks to users by selecting the first location and the second location to assign the tasks to users in the first location and the second location.

8. The system of claim 7, wherein the task management module is configured to associate a pending task list with users representing one or more tasks assigned to the user.

9. The system of claim 8, wherein the task management module is configured to update a task status on the pending task list as one of not started, in progress or completed based upon a user selection.

10. The system of claim 9, wherein the task management module is configured to assign one or more tasks based on predefined business rules.

11. The system of claim 10, wherein the predefined business rules establish a task workflow in which all tasks are initially approved or rejected by a gatekeeper.

12. The system of claim 11, wherein the task management module includes a workload analyzer configured to identify a workload for a selected business process.

13. The system of claim 12, wherein the task management module is configured to report on tasks assigned to the first location and the second location.

14. The system of claim 1, wherein the audit management module is configured to create a checklist of different activities related to business operations for assignment to a group of users.

15. The system of claim 14, wherein the audit management module is configured to generate a scoresheet indicative of completion status of the checklist of business activities.

16. A computer system for supporting various business processes of a business entity having a plurality of locations including a first location and a second location, the computer system comprising:
at least one processor;
a network interface;
a memory element coupled to the processor, the memory storing instructions to direct the processor to perform operations comprising:
creating one or more cubes of data extracted from a data warehouse;
upon receciving a request for a key performance indicators (“KPIs”) report, determining a user role of a user requesting the report; and
populating a predefined KPI based on the cubes of data and responsive to determination the user role.

17. The computer system of claim 16, wherein the processor is programmed with a task management module configured to present an interface from which a user can define one or more tasks for assignment to one or more users by associating a task name, a task description and one or more of a duration of the task, priority of the task, task category, and task budget.

18. The computer system of claim 17, wherein the task management module is configured to assign one or more tasks by selecting a geographical region of users to whom the task is assigned.

19. The computer system of claim 17, wherein the task management module is configured to associate a pending task list with users representing one or more tasks assigned to the user.

20. The computer system of claim 17, wherein the task management module is configured to update a task status as one of not started, in progress or completed based upon a user selection.
